(19) United States
(12) Patent Application Publication
(10) Pub. No.: US 2003/0117978 A1
(43) Pub. Date: Jun. 26, 2003

(54) Inter-network transfer

(75) Inventor: Wassim Haddad, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT PACKARD COMPANY

(21) Appl. No.: 10/323,775

(22) Filed: Dec. 20, 2002

(30) Foreign Application Priority Data
Dec. 20, 2001 (GB) 0130615.8

(51) Int. Cl. H04L 1/00

(52) U.S. Cl. 370/331; 370/338

(57) ABSTRACT

A method of routing a mobile device connection between a first network (700) and a second network (710) comprises the steps of, providing a software agent upon a processing element, monitoring a data transfer application resident upon, and/or input-output (IO) port of, the device (720) using the software agent and determining whether the application requires mobile network addressing upon the device (720) moving from the first network (700) to the second network (710) to maintain said connection using the results of the monitoring.

### FIELD OF INVENTION

This invention relates to a method for, and a data structure arranged to, transfer a mobile network element between networks, and associated systems.

### BACKGROUND OF INVENTION

Mobile Internet Protocol (IP) systems for effecting the transfer of a mobile network element between networks are known, see for example FIGS. 1 and 2. In one such mobile IP arrangement, shown in FIG. 1, a mobile network element (MNE), for example a personal digital assistant (PDA) or a laptop computer, resides within a home network, typically a local area network (LAN) or a wireless LAN (WLAN), that usually has an external server attached to thereto. The home network contains a home routing agent, typically a software agent resident upon a machine on the network.

Upon the MNE leaving the home network any application session running thereupon that involves data transfer is terminated. As the MNE enters, or is connected to, a foreign network the foreign network registers the MNE's IP address, which is its IP address within its home network, with a foreign routing agent upon the foreign network. The foreign routing agent will typically send the information that the MNE is within the foreign network to the home agent.

Should the MNE want to receive data from the server whilst in the foreign network the server must first send the data to the home agent where an additional IP address corresponds to that of the foreign agent is inserted into a data packet header prior to its forwarding to the foreign agent, a process known as tunnelling, as shown in FIGS. 4 and 5. The foreign agent strips the additional IP address data from the packet header and consequently recognises it as being destined for the MNE. The MNE can send data to its home network by direct routing of the data using its home network IP address, this arrangement is known as a triangular routing arrangement. Thus, the home and foreign agents act as “mailboxes” for network elements that are no longer within their own home networks.

In the case of a WLAN, for example employing IEEE802.11, HIgh PEformance Radio LAN (Hiperlan) or Bluetooth, where there are multiple access points each having a radiation footprint that slightly overlaps the footprint of the adjacent access point, shown in FIG. 1, a horizontal hand-over (handoff) wherein a MNE moving between footprints maintains its own IP address within the LAN. This horizontal hand-over does not necessitate the insertion of an additional IP address into a packet header, as it does not involve the MNE leaving the LAN. The hand-over occurs at the datalink layer of the open systems interconnect (OSI) reference model, as shown in FIG. 3, specifically it occurs at the medium access control sub layer.

However, should the MNE leave the LAN and enter a cellular telecommunications network, a so-called intertech example of macromobility, an ascendant vertical hand-over between LAN and cellular networks occurs. In this case, the hand-over occurs at the network layer of the OSI reference model, typically via the Internet Protocol. This has the problem that any data transfer application will be dropped at the point of hand-over.

Similarly, descendent vertical hand-overs between cellular networks and LAN's cause data transfer applications to be dropped. Vertical hand-overs occurs between cells of different hierarchy level, as shown in FIG. 2, or belonging to a different access technologies.

The re-establishment of network connections to the foreign network requires the use of mobile routing that requires expensive routing equipment capable of adding and stripping data segments to/from headers. This also ties up network bandwidth and processor capacity.

A particular problem associated with intertech hand-overs is that the metric of payment may change, for example, network usage of a WLAN can be paid for on the basis of time of usage of a network whereas network usage of a GPRS connection is paid for on the basis of bandwidth utilisation. This can lead to significant changes in the cost of handling the same data over a network. Or indeed, a user may be required to pay for multiple communications to maintain his/her connection.

Prior art arrangements include those shown in WO 0/59178, which monitor encapsulated (using the terminology of the enhancement to Internet Protocol version 4 (IP v4)) addresses associated with an IP datagram. The presence of an encapsulated address is used to determine the properties of the destination network and therefore whether data being transmitted is suitable for the destination network. Such an arrangement relies upon Mobile IP as discussed above and the associated routers, etc.

### SUMMARY OF THE INVENTION

According to a first aspect of the present invention there is a provided method of transfer of routing a mobile device connection between a first network and a second network comprising the steps of:

i) providing a software agent upon a processing element;

ii) monitoring a data transfer application resident upon, and/or input-output (IO) port of the device using the software agent; and

iii) determining whether the application requires mobile network addressing upon the device moving from the first network to the second network to maintain said connection using the results of the monitoring.

In determining whether a data transfer application requires mobile addressing to be used the method mitigates against the unnecessary provision of mobile addressing on a network thereby reducing network traffic, freeing network bandwidth and reducing the load on processors within the networks. It also reduces the amount of complex and expensive routing equipment that is required in the network architecture, and may save the user of the networks unnecessary expense.

The method may include monitoring data transfer applications by interrupting a processor of the device. Alternatively and/or additionally, the method may include monitoring data traffic through the at least one IO port. These arrangements allow the data transfer applications to be monitored either directly or by tracking data through the IO port assigned to each transfer Protocol, for example HTTP usually resides on Port 80.

The method may include providing the processing element within the mobile device. Alternatively the method may include providing the processing element within a network element connected to the first network and arranged to transfer data relating to whether the application requires mobile network addressing upon the device moving from the first network to the second network using the results of the monitoring a network element connected to the second network.

The method may include establishing a network connection to the second network. The method may include providing mobile network addressing in the form of mobile Internet Protocol (IP).

The method may include determining a suitable mode of connection to the second network by the software agent. The method may include providing a WLAN connection and/or a cellular telecommunication connection to the second network. The method may include basing the determination of the suitable mode of connection upon any one, or combination, of the following: method of costing, available bandwidth, network reliability, assured quality of service. This allows the mode of connection to be determined by the software agent with a view to minimising the cost of a connection, for example, general packet radio service (GPRS) usage is based upon bandwidth utilisation and thus it may be cheaper to use GPRS than a WLAN where a user is charged on a unit time basis for transmitting speech. Other factors can be considered including assured quality of service (QOS) where a user has a contract guaranteeing a certain QOS, for example over a cellular telecommunications network, they may wish to use this network in preference to any other.

The method may include providing either, or both, of the first and second networks primarily in the form of a wireless local area network (WLAN). The method may include providing the WLAN in the form of any one of the following: IEEE 802.11, Bluetooth, Hiperlan.

The method may include providing a cellular telecommunications link between a data source, and the device. The method may include using any one of the following cellular telecommunications protocols in the provision of the cellular telecommunications link: global system for mobile telecommunications (GSM), GPRS, 3G, (universal mobile telecommunications system (UMTS)).

The method may include refreshing an application that does not require mobile addressing from a memory or a cache within the device. The method may include having more than one data transfer session associated with a data transfer application. The method may include connecting each data transfer session to the second network.

The method may include retaining within the software agent a database containing details of any one, or combination, of the following: active data transfer sessions, whether mobile addressing is required, network connections available, preferred network connections, active (IO) port number.

The method may include monitoring any one, or combination, of the following types of data transfer application: File Transfer Protocol (FTP), Hyper Text Transfer Protocol (HTTP), real time (time bounded) applications.

The method may include restarting data transfer upon establishing a connection with the second network. This may be advantageous in situations where a connection does not need to be maintained and allows each individual data transfer session to be restarted from the beginning. Further, it may be advantageous if the data being transferred is corrupted by the original sessions being dropped.

Alternatively and/or additionally, the method may include resuming data transfer upon establishing a connection with the second network. Thus, data transfer can be resumed if the data is not corrupted on dropping the original session.

The method may include providing the device in the form of any one of the following: mobile telephone, laptop computer, personal digital assistant (PDA), e-book, MP3 recorder/player, watch.

According to a second aspect of the present invention there is provided a memory device encoded with a data structure, the data structure arranged to determine whether a data transfer application, resident upon a mobile device, requires mobile network addressing upon the mobile device moving from the first network to the second network, the data structure containing entries relating to:

i) application type;

ii) application usage; and

iii) a requirement for mobile addressing.

The data structure may be arranged to facilitate mobile addressing, typically mobile IP, of the device within the second network in response to the content of the entry relating to the requirement for mobile addressing.

The data structure may be encoded upon a memory device within the mobile device.

There may be a plurality sets of entries within the data structure relating to a plurality of data transfer applications. There may be a plurality of subsets of entries in the data structure relating to a plurality of active data transfer sessions associated with the, or each, data transfer application.

The entry relating to application type may include details of any one, or combination, of the following types of data transfer applications: FTP, HTTP, real-time (time bounded) applications.

The entry relating to application usage may include results from an interruption and interrogation of a processor of the device. Alternatively, and/or additionally, it may include results from an interruption and interrogation of an IO port of the device.

The data structure may include an entry relating to network connection type selection criteria. The data structure may be arranged to facilitate the selection of a preferred network connection type for the, or each, data transfer application. The data structure may be arranged to facilitate the connection of the, or each, data transfer application to the second network, typically using the preferred network connection type for the, or each, data transfer application. The preferred network connection type for the, or each, data transfer application may be any one of the following: infra red, radio frequency, cellular telecommunications. The infra red connection may employ any one of the following protocols: IEEE802.11, Bluetooth, Hiperlan. The cellular telecommunications connection may employ anyone of the following protocols: GSM, GPRS, 3G, UMTS.

According to a third aspect of the present invention there is provided a mobile device having a software agent resident thereupon, the software agent arranged to monitor data transfer applications resident upon, and/or IO ports of the device and to determine which, if any, of the applications require mobile network addressing upon the device moving from a first network to a second network.

The mobile device may be any one of the following: mobile telephone, PDA, laptop computer, e-book or MP3 recorder/player.

According to a fourth aspect of the present invention there is provided a network element in a first network arranged to receive data from a mobile device temporarily resident in the first network having a network address associated with a second network and mask the origin of the data such that the data can enter the second network through a security screen arranged to prevent data bearing a source network address associated with the second network from entering the second network.

This arrangement allows the transfer of data from a mobile device in a foreign network into its home network through a screen (may be a firewall) which is not possible using the standard triangular routing arrangement.

The network element may be a PC, a server, a mobile telephone, a laptop computer or a PDA. The network element may have a software agent running thereupon arranged to mask the origin of the data.

The data may be a data packet with a header and a payload. The network element may be arranged to insert (collocate) a network address associated therewith into the header, typically adjacent the source network address.

The mobile device may be wirelessly linked to the network element. The method device may be wirelessly linked to the network element using any one, or combination, of the following wireless communication protocols to link the mobile device to the network element: IEEE 802.11, Bluetooth, Hiperlan, GSM, GPRS, 3G (UMTS). The mobile device in the form of any one of the following: mobile telephone, PDA, laptop computer, e-book, MP3 recorder/player.

The screen may be a firewall.

The second network may include a further network element arranged to unmask the origin of the data. The further network element may be arranged to route the data to its destination. The further network element may be arranged to strip the inserted network address from the header.

The further network element may be a PC, a server, a mobile telephone, a laptop computer or a PDA. The further network element may have a software agent running thereupon arranged to unmask the origin of the data.

According to a fifth aspect of the present invention there is provided a method of transferring data from a first network to a second network where the mobile device is temporarily resident in the first network and has a network address associated with a second network such that the data can enter the second network through a security screen arranged to prevent data bearing a source network address associated with the second network from entering the second network comprising the steps of:

i) transmitting data from the mobile device to a network element of the first network;

ii) inserting a network address associated with the network element into the data;

iii) passing the data to the screen;

iv) reading of the inserted network address by the screen;

v) determining that the inserted network address is from a network other than the second network; and

vi) allowing the data to enter the second network.

The skilled person will appreciate that it may be possible to re-order some of the steps. For example, steps i, and ii may be reversed such that it is the mobile device that inserts the network address, before transmission to the network element.

The method may include providing the data in the form of a packet, typically having a header and a payload. The method may include inserting the network address into the header, typically adjacent the source network address.

The method may include providing the screen in the form of a firewall.

The method may include passing the data to a further network element of the second network. The method may include stripping the inserted network address from the data.

The method may include routing of the data to its destination by the further network element.

The method may include providing each, or both, of the network element and the further network element in the form of any one of the following: a PC, a server, a mobile telephone, a laptop computer or a PDA.

The method may include linking the mobile device to the network element. The method may include using any one, or combination, of the following wireless communication protocols to link the mobile device to the network element: IEEE 802.11, Bluetooth, Hiperlan, GSM, GPRS, 3G, (UMTS). The method may include providing the mobile device in the form of any one of the following: mobile telephone, PDA, laptop computer.

According to a sixth aspect of the present invention there is provided a computer readable medium having stored therein instructions for causing a device to execute the method of either of the first or fifth aspects of the present invention.

The medium may comprise any one or more of the following: a ROM/RAM, or any other form of memory, floppy disk, a CDROM, a DVD ROM/RAM (including variants such as +R, −R, etc.), a magneto optical disk, tape, a transmitted signal (which may be an Internet down load or the like), a wire, any other suitable medium.

According to a seventh aspect of the present invention there is provided a program storage device readable by a mobile device and encoding a program of instructions which when operated upon the mobile device cause it to act as the mobile device according to the third aspect of the present invention or as an element of the system of the fourth aspect of the present invention.

The method may comprise a system upon which the method according to the first aspect of the invention is run.

### BRIEF DESCRIPTION OF THE DRAWINGS

The invention will now be described, by way of example, with reference to the accompanying drawings in which:

FIG. 1 is a schematic representation of prior art horizontal and intertech hand-over arrangements;

FIG. 2 is a schematic representation of a prior art vertical hand-over arrangement;

FIG. 3 is a diagram of the open systems interconnection (OSI) reference model showing the layers at which horizontal hand-over and macro mobility occur;

FIG. 4 is a schematic representation of a data packet configured for tunnelling using the arrangement of FIG. 5;

FIG. 5 is a schematic representation of a prior art forward tunnelling arrangement.

FIG. 6 is a flowchart detailing a method of network transfer according to an aspect of the present invention;

FIG. 7 is a schematic representation of an embodiment of a network transfer arrangement according to an aspect of the present invention;

FIG. 8 is a schematic representation of a reverse tunnelling arrangement according to an aspect of the present invention; and

FIG. 9 is a flowchart detailing a method of reverse tunnelling according to an aspect of the present inventions.

### DETAILED DESCRIPTION OF THE DRAWINGS

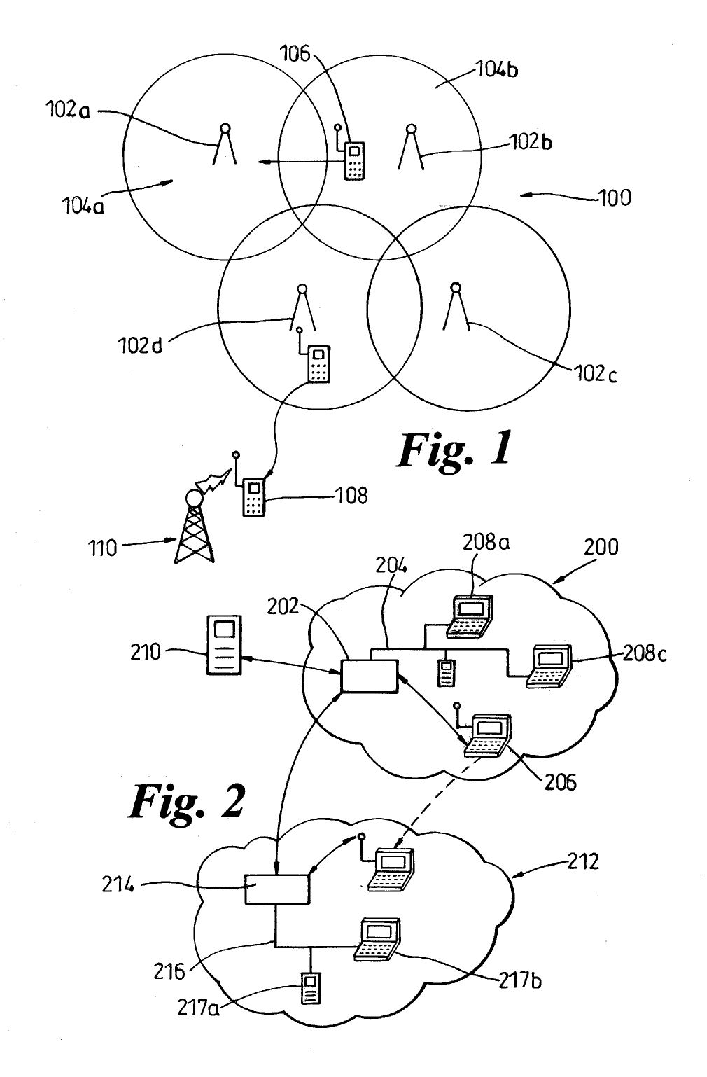

Referring now to FIG. 1 a wireless local area network (WLAN) 100 comprises a number of access points 102a-d, each having an associated radiation footprint 104a-d. Each radiation footprint 104a typically overlaps with the adjacent footprints 104b,d. A mobile device 106, for example a mobile telephone or a personal digital assistant, that is involved in data transfer with one of the access points 102b, does not need to break its connection with the WLAN 100 upon exiting the footprint 104b of the access point 102b and entering the footprint 104a of the access point 102a. This is because the network address, typically the Internet Protocol (IP) address of the device 106 remains unaltered whilst it remains within the WLAN 100. This is horizontal hand-over within a network.

Should a mobile device 108 leave the WLAN 100 and enter a cellular network 110, for example a general packet radio service (GPRS) network, it must drop all data transfer connections. The device 108 re-establishes data transfer connections within the cellular network 110, using cellular protocols, once a network address, typically either a new address or one using a foreign agent, within the network 110 has been established. This is an intertech, vertical, hand-over between networks.

Referring now to FIG. 2, a home network 200 comprises a home agent 202, a network spine 204 and a mobile device 206, typically a laptop computer, PDA or mobile telephone.

The home agent 202 is usually a software agent running upon a server or a computer. The home agent 202 is arranged to communicate with various devices 208a-c connected to the network spine 204. Additionally, the home agent 202 is arranged to communicate with a server 210 that is external of the home network 200 and is arranged to communicate with the mobile device 206 via a wireless connection.

The home agent 202 regulates the flow of data into and out of the home network 200, for example a data transfer path between the mobile device 206 and the server 210 is established via the home agent 202 as the server 210 is external of the network 300.

A foreign network 212 comprises a foreign agent 214 and a network spine 216 having devices 217a, b connected thereto.

Should the mobile device 206 leave its home network 200 all data transfer connections, for example the server 210 to mobile device 206 connections or any connections between any of the devices 208a-c and the mobile device 206, are dropped. Typically, any data being transferred at the time of the interruption is corrupted, although smart File Transfer Protocol (FTP) applications do exist that allow sequential transfer of data following such a dropped connection.

Upon entering the foreign network 212 the mobile device 206 still retains its original network (IP) address from the home network 200. The foreign agent 214 broadcasts an advertisement within the foreign network 212 periodically that gives notice to any visiting devices within the network 212 of the ability of the foreign agent to provide all of the network parameters necessary for the visiting devices to connect to the foreign network 212. The mobile device 206 registers with the foreign agent 214 and receives the network parameters that enable it to connect to the foreign network 212 from the foreign agent 214.

In transferring data to the mobile device 206 within the foreign network 212 the home agent 202 collocates its own network address with the home network address of the mobile device 206 by inserting a segment into the header of a data packet originating from the server 210, see FIG. 4.

The data packet is sent from the home agent 202 to the foreign agent 214.

The foreign agent 214 strips the collocated network (IP) address from the packet and routes it upon its way to the mobile device 206. Data passed from the mobile device 206 to the server 210 is routed directly to the home agent 202 by the mobile device 206 and then on to the server 210, thus forming a triangular routing arrangement.

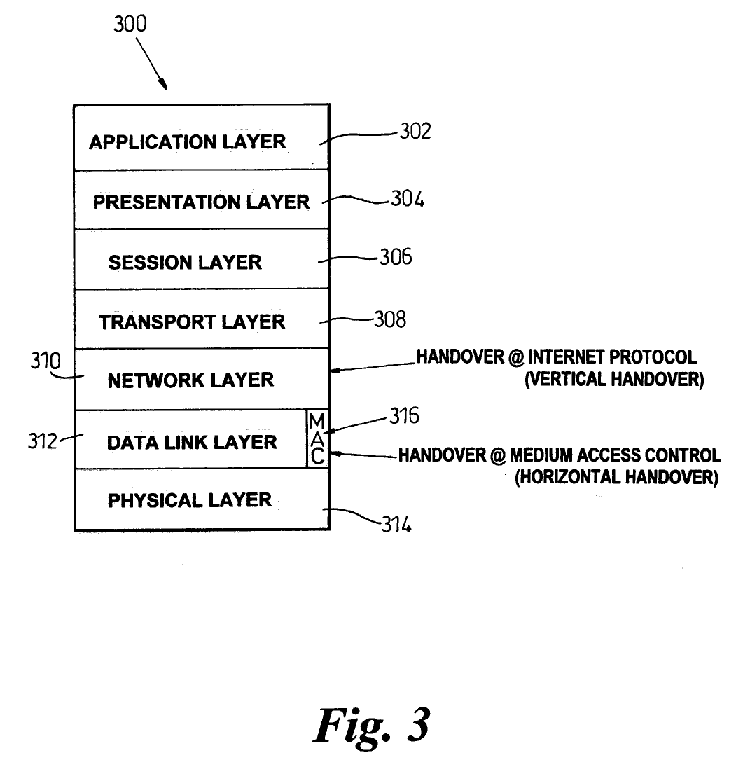

FIG. 3 shows the 7-layer OSI reference model 300 of communication system structuring. The 7 layers are as follows: application layer 302, presentation layer 304, session layer 306, transport layer 308, network layer 310, data link layer 312 and physical layer 314.

Horizontal hand-overs occur at the data link level 312, preferably at a medium access control (MAC) sub level 316 of the data link level 312 should the communication system include one. This is because the link to the home network need not be dropped, only transferred from one access point to another. Data communication continues suffering only the insignificant delay associated with the transfer between access points.

Intertech, vertical hand-overs occur at the network layer 310, as they require the use of new or foreign agent network (IP) addresses in order to accommodate differing communications protocols between networks, for example in mobile IP. This allows the communication of data to the devices home network from a foreign network that would otherwise be rejected. The reason for the rejection of data from a foreign network by the devices home network is that, without a new or foreign agents' network address, a home agent cannot accept that a data packet with a network (IP) address from within the devices home network originates from outside the device home network.

Referring now to FIG. 4, a data packet 400 comprises payload 402 and a head 404. The payload 402 includes the data content to be transferred between devices. The header 404 includes a source address segment 406 and a destination address segment 408. If the packet 400 is routed using mobile IP the network (IP) address of the home agent 202 is spliced into the header 404 in a collocated address segment 410 adjacent the source address segment 406. The collocated address segment 410 is removed by the foreign agent 214 prior to it routing the packet to the mobile device 206.

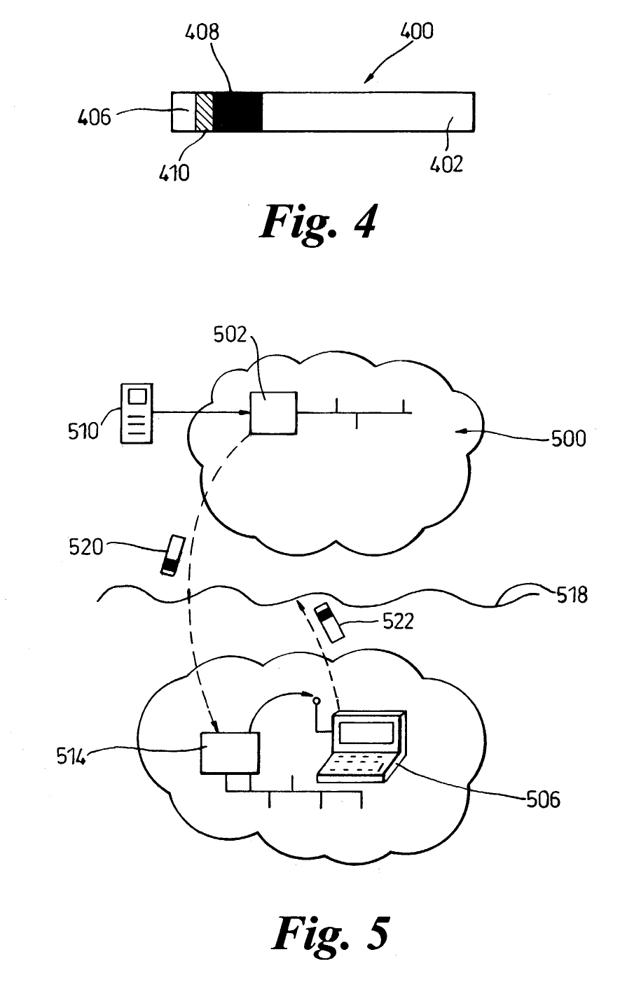

Referring now to FIG. 5, a forward tunnelling arrangement 500 is substantially similar to the arrangement of FIG. 2 and similar parts will be accorded similar reference numerals in the five hundred series.

A firewall 518 associated with the home network 500 provided between the home network 500 and the foreign network 512. The purpose of the firewall 518 is to prevent unauthorised access to the home network 500. The firewall 518 also serves to screen incoming data packets in order to prevent viruses and reject data from an external source claiming to originate from within the home network.

In a forward tunnelling arrangement a data packet 520 passes from the home agent 502, passes the firewall 518, to the foreign agent 514. The data packet 520 has its collocated address segment stripped off and is transmitted to the mobile device 506, as described hereinbefore. However, a data packet 522 sent by the mobile device 506 to the home network 500 cannot penetrate the firewall 518 as the firewall 518 does not allow data packets with IP address segments containing an IP address from within the home network 500 to enter the home network 500 as it views such data packets as spurious and a security risk.

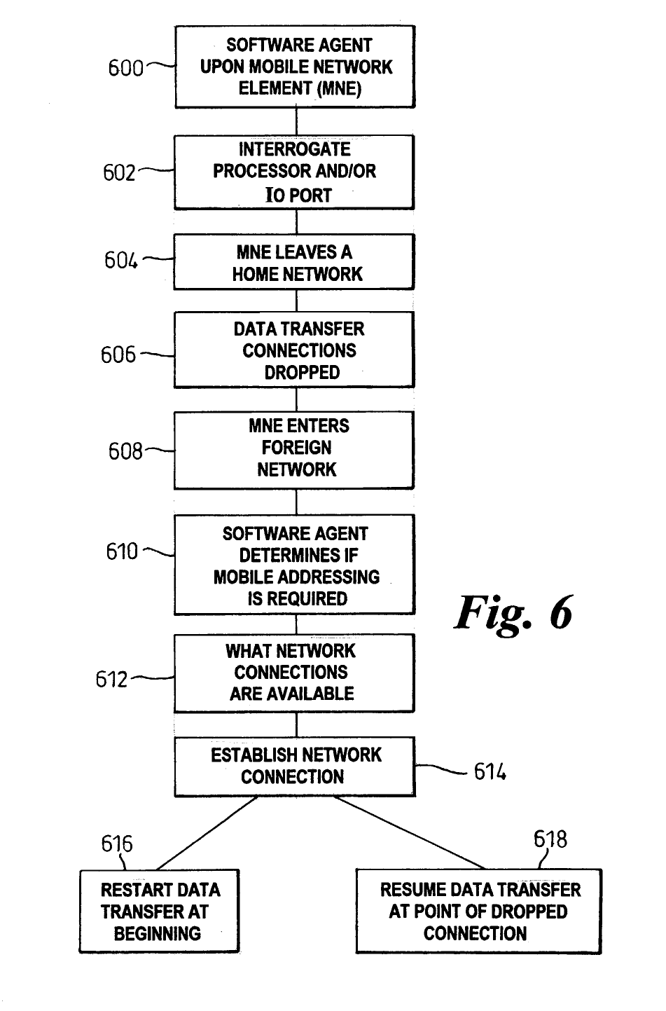

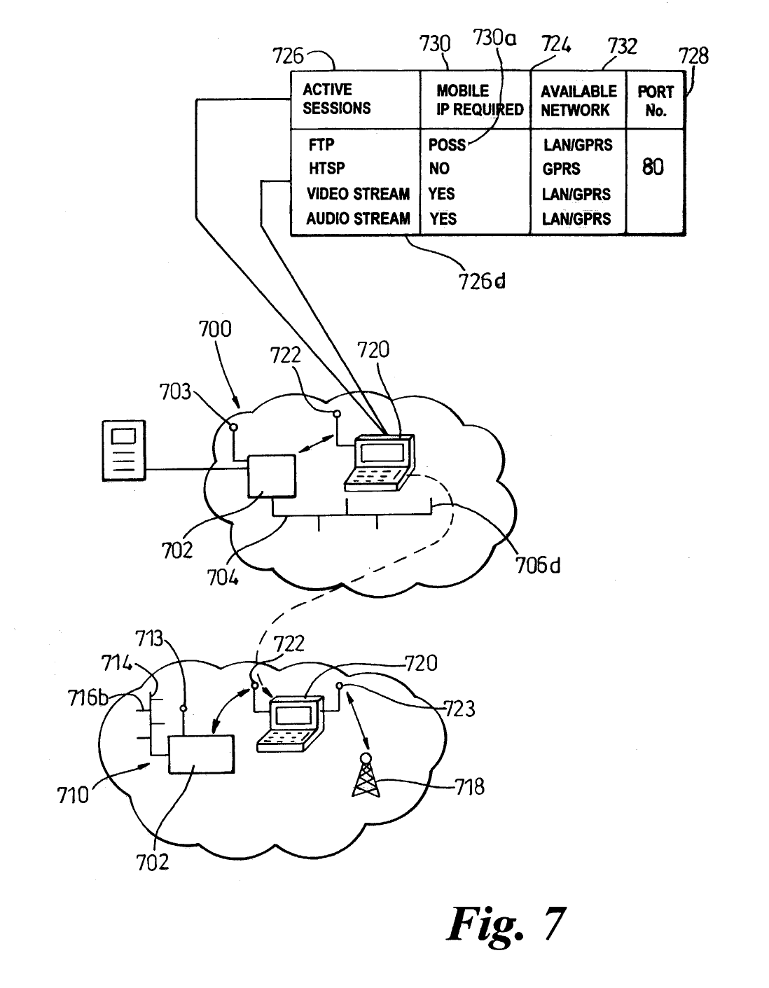

Referring now to FIG. 6, a method of transferring a mobile network element (MNE) between networks includes providing a software agent that is arranged to monitor data transfer sessions and/IO ports upon the MNE (step 600). The software agent interrogates the processor and/or scans the IO ports (step 602) whenever a hand-over occurs in order to ascertain which applications/ports are active whilst the MNE is in a home network. As each data transfer application has a unique port identifier associated with it the scanning of the IO ports allows the determination of which applications require the use of mobile IP and which do not.

The MNE leaves the home network (step 604) and data transfer connections are dropped (step 606). The MNE then enters a foreign network (step 608).

The software agent determines which, if any, of the dropped data transfer sessions require the use of mobile addressing to re-establish (step 610). The software agent typically also determines what network connections (e.g. LAN, cellular) are available over which the data transfer session can be re-established (step 612). The software agent can be configured to reestablish a dropped data transfer session over the most appropriate, or preferred, network (step 614) based either on costings or bandwidths availability.

The MNE either restarts the dropped data transfer session at the beginning (step 616) if the data being transferred is corrupted and unusable or it picks up a data transfer session at the point in the data being transferred where the session was dropped (step 616) if continuity in the data transfer process is possible.

Referring now to FIG. 7, a home network 700 comprises a home agent 702 including a wireless transceiver 703 a LAN backbone 704 with nodes 706a-d. An external server 708 connects to the home address 700 via the home agent 702. Each of the nodes 706a-d typically has a network element, such as, for example, a server, a PC, a PDA or a printer associated with it.

A foreign network 710 comprises a foreign agent 712, including a wireless transceiver 713 a LAN backbone 714 with nodes 716a-d and a cellular transceiver 718.

A mobile network element (MNE) 720 includes a wireless transceiver 722 that is arranged to communicate with wireless transceiver 703 of the home agent 702 and a cellular transceiver 723. The MNE 720 has a software agent 724 running thereupon that monitors either, or both, of active data transfer sessions 726 upon the MNE 710 or/and active ports 728 of the MNE 710. The software agent 724 also details whether mobile addressing is necessary 730 and which networks are available/preferred 728, 732. The MNE 720 will typically be a mobile telephone, a laptop computer, a PDA, an e-book or an MP3 player/recorder.

The MNE 720 leaves the home network 700 and enters the foreign network 710. This results in the dropping of all data transfer operations that are in progress, as noted hereinbefore for the prior art arrangements. However, the software agent 724 maintains a list of the active data transfer sessions 726, whether they require mobile addressing 730 and which telecommunications networks are available and/or preferred 732.

For example, a File Transfer Protocol (FTP) session 726a may possibly require mobile addressing 730a as it may be a smart FTP session that can restart the FTP session at the point within the file being transferred where it was broken.

A Hyper Text Transfer Protocol (HTTP) session 726b will not typically require the use of mobile addressing since it does not matter to a user if his/her session is stopped and re-started in the second network. In the case of video streaming, or any other real time application, the connection will typically be maintained using mobile IP.

Video and audio streaming sessions 726c,d with data originating from the server 708 will require mobile addressing as it is necessary for the data to be passed via the home agent 702 to the foreign agent 704 and on to the MNE 720 in a triangular routing arrangement as described hereinbefore.

The software agent 724 also contains details of the networks available 732 each of for the data transfer session 726a-d. This allows the agent 724 to determine the most appropriate network and/or network type, for example LAN or cellular, for any given data transfer sessions 726a-d.

The assessment of which network type is the most appropriate is typically based upon considerations such as mode of billing, bandwidths available and quality of service.

For example, in general packet radio service (GPRS) networks it is envisaged that a user will be billed upon the amount of bandwidth that they utilise rather than their time connected to the network. Thus, for low bandwidth data transfer such as poor quality audio signals and text based file transfer GPRS channels are an attractive option as these applications are low bandwidth and therefor low cost over a GPRS network. However, a wireless LAN (WLAN) is a far more attractive option for high bandwidth applications such as real time video as bandwidth usage is not a basis for charging transfer. It is entirely conceivable, for example, that a videoconference could be conducted with the video feed being transmitted over a WLAN and the audio stream being transmitted over a low bandwidth, low cost, GPRS channel.

Each type of data transfer application, e.g. FTP, HTTP, video streaming, audio streaming will have an input/output (IO) port associated with it on a network interface card (NIC) of the MNE 720. An alternative to monitoring active data transfer sessions directly is to monitor the traffic through the port associated with each data transfer application, for example monitoring port 80 gives an indication of HTTP traffic.

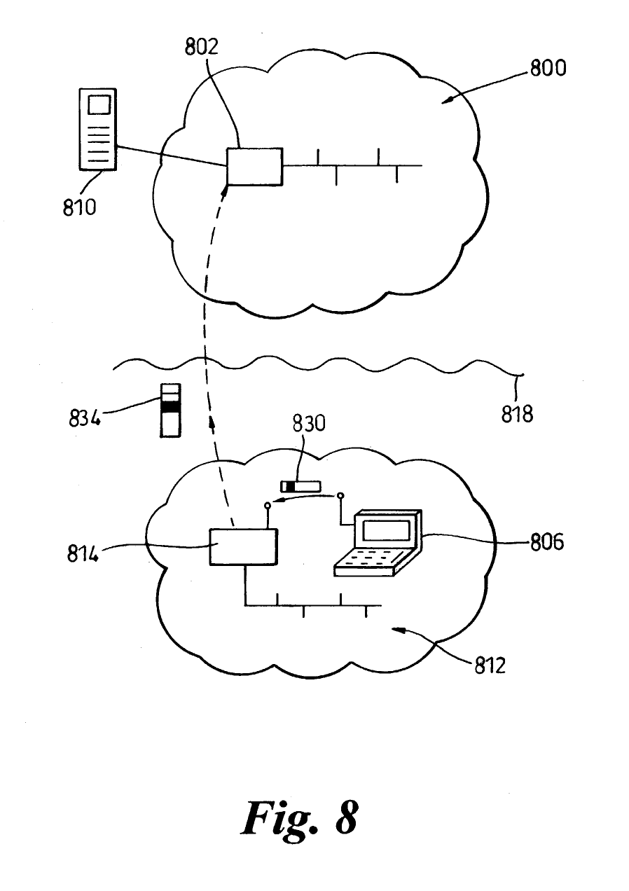

Referring now to FIG. 8, similar parts to those of FIG. 5 and accorded similar reference numerals in the eight hundred series.

The mobile device 806 passes a data packet 830 to the foreign agent 814 where a collocated foreign agent address data segment 834 is inserted into the packet 830. The data packet 830 can now pass through the firewall 818 as the collocated address data segment 834 is sensed by the firewall 818 not the home network address of the mobile device 806, such that the firewall 818 does not perceive the packet 830 to be a security risk, as described hereinbefore with reference to FIG. 5.

The home agent 802 is configured to strip the collocated foreign agent address data segment 834 from the packet and route it to its destination, for example the server 810.

Thus, this arrangement allows the reverse tunnelling of data packets from the mobile device 806 through the firewall 818 by the masking of the origin by collocating the foreign agents' network (IP) address with the devices' own network address.

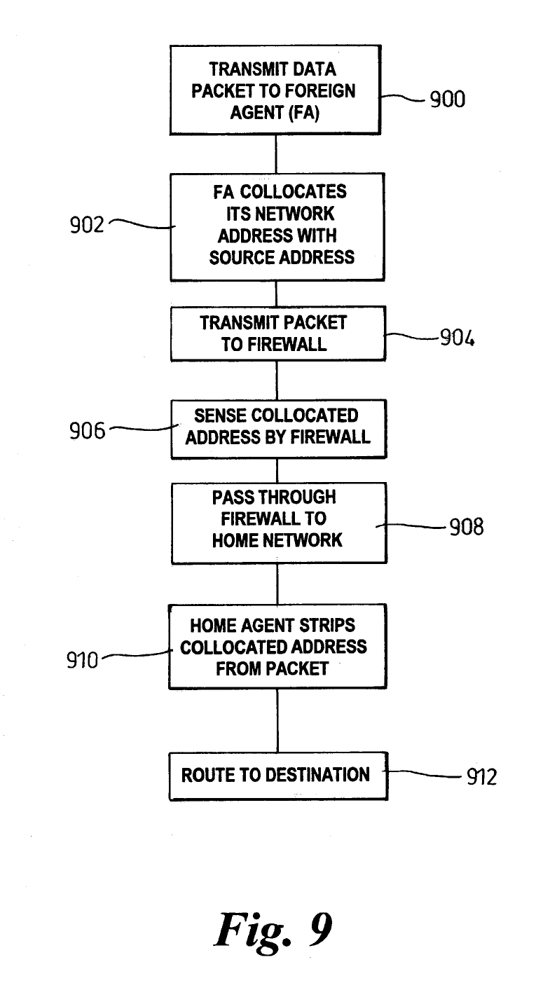

Referring now to FIG. 9, a mobile device transmits residing in a foreign network a data packet to a foreign agent (Step 900). The foreign agent collocates its network address with the source address of the mobile device into the packet (Step 902).

The foreign agent transmits the packet to a firewall (Step 904). The firewall senses the collocated address not the mobile device's address (Step 906) and allows the packet to pass and enter the home network (Step 908).

The home agent strips the collocated address from the packet (Step 910) and then routes the packet to its destination (Step 912).

1. A method of routing a mobile device connection between a first network and a second network comprising the steps of:
i) providing a software agent upon a processing element;
ii) monitoring with said software agent at least one of a data transfer application resident upon said mobile device, and an input-output (IO) port of said mobile device; and
iii) determining, using the results of said monitoring, whether said data transfer application requires mobile network addressing upon said mobile device moving from said first network to said second network to maintain said connection.

2. The method of claim 1 including providing said processing element within said mobile device.

3. The method of either of claims 1 including establishing a network connection to said second network.

4. The method of claim 1 including monitoring data traffic through said at least one IO port and using said monitoring to determine whether the application requires mobile network addressing.

5. The method of claim 1 including basing said determination as to whether mobile network addressing is required upon at least one of the following group: method of costing, cost of the connection, available bandwidth, network reliability, assured quality of service.

6. The method of claim 1 including having more than one data transfer session associated with a data transfer application and making said determination as to whether mobile network addressing is required for each said data transfer session.

7. The method of claim 1 including retaining within said software agent a database containing details of at least one from the group: active data transfer sessions, whether mobile addressing is required, network connections available, preferred network connections, active (IO) port number.

8. The method of claim 3 including restarting data transfer associated with said data transfer application upon establishing a connection with said second network.

9. The method of claim 3 including resuming data transfer associated with said data transfer application upon establishing a connection with said second network.

10. A memory device encoded with a data structure, said data structure arranged to determine whether a data transfer application, resident upon a mobile device, requires mobile network addressing upon said mobile device moving from a first network to a second network, said data structure containing entries relating to:
i) application type;
ii) application usage; and
iii) a requirement for mobile addressing.

11. A memory device according to claim 10 wherein said data structure is encoded upon a memory device within said mobile device.

12. A memory device according to claim 10 wherein said data structure is arranged to facilitate the selection of a preferred network connection type for said at least one data transfer application.

13. A memory device according to claim 12 wherein said data structure is arranged to facilitate the connection of said at least one data transfer application to said second network using the preferred network connection type for said at least one data transfer application.

14. A memory device according to claim 12 wherein said preferred network connection type for said at least one data transfer application is any one of the following: infra red, radio frequency, cellular telecommunications.

15. A mobile device having a network connection to a first network and further having a software agent resident thereupon, said software agent arranged to monitor at least one of at least one data transfer application resident thereupon and at least one IO port of said device and to determine if said at least one data transfer application requires mobile network addressing upon said data transfer device moving from said first network to a second network.

16. A data transfer system including at least one network element in a first network arranged to receive data from a mobile device temporarily resident in said first network and having a network address associated with a second network and mask the origin of said data such that said data can enter said second network through a security screen arranged to prevent said data bearing a source network address associated with the second network from entering said second network.

17. A system according to claim 16 wherein said network element has a software agent running thereupon arranged to mask the origin of said data.

18. A system according to claim 16 wherein said data comprises at least one data packet with a header and a payload and said network element is arranged to insert a network address associated therewith into said header.

19. A system according to claim 16 wherein said screen is a firewall.

20. A system according to claim 16 wherein the second network includes a further network element arranged to unmask the origin of the data.

21. A system according to claim 20 wherein said data comprises at least one data packet with a header and a payload and said network element is arranged to insert a network address associated therewith into said header and wherein said further network element is arranged to strip said inserted network address from said header.

22. A method of transferring data from a first network to a second network where a mobile device is temporarily resident in said first network and has a network address associated with a second network such that data can enter said first network through a security screen arranged to prevent data bearing a source network address associated with said second network from entering said first network comprising at least the following steps, the order of which may be altered:
i) transmitting data from said mobile device to a network element of said first network;
ii) inserting a network address associated with said network element into said data;
iii) passing said data to said screen;
iv) reading of said inserted network address by said screen;
v) determining that said inserted network address is from a network other than said second network; and
vi) allowing said data to enter the first network.

23. The method of claim 22 including providing said data in the form of a packet having a header and a payload and inserting said network address into said header.

24. The method of claim 22 including providing the screen in the form of a firewall.

25. A method of routing a connection from mobile device to a first network between said first network and a second network comprising the steps of:
i) providing a software agent upon a processing element within said mobile device;
ii) monitoring with said software agent at least one of a data transfer application resident upon said mobile device, and an input-output (IO) port of said mobile device;
iii) determining, using the results of said monitoring, whether said data transfer application requires the use of mobile network addressing, to maintain said connection, when said mobile device moves from said first network to said second network; and
iv) if it is determined that mobile network addressing is not required dropping said connection to said first network and establishing a connection to said second network.

26. The method of claim 25 including basing said determination as to whether mobile network addressing is required upon at least one of the following group: method of costing, cost of the connection, available bandwidth, network reliability, assured quality of service.

27. The method of claim 25 including having more than one data transfer session associated with a data transfer application and making said determination as to whether mobile network addressing is required for each said data transfer session.

28. The method of claim 25 including one of restarting and resuming data transfer occurring on said data connection before dropping thereof on said connection to said second network.

29. The method of claim 25 in which said mobile device can connect to both said first and said second networks simultaneously.

30. A mobile device having a network connection to a first network and further having a software agent resident thereupon, said software agent arranged to monitor at least one of at least one data transfer application resident thereupon and at least one IO port of said device and to determine if said at least one data transfer application requires mobile network addressing upon said data transfer device moving from said first network to a second network; said device is further arranged to drop said network connection to said first network and to establish a connection with said second network if it is determined that mobile network addressing is not required.

31. A mobile processing means for processing data having a network connection to a first network said processing means being arranged to monitor at least one of at least one data transfer application resident thereupon and at least one IO port of said processing means and further arranged to determine if said at least one data transfer application requires mobile network addressing upon said processing means moving from said first network to a second network wherein said processing means is further arranged to establish a connection with said second network if it is determined that mobile addressing is not required.
